(19) United States
(12) Patent Application Publication
(10) Pub. No.: US 2025/0265577 A1
(43) Pub. Date: Aug. 21, 2025

(54) SYSTEM AND METHODS FOR VALIDATING RESOURCE TRANSFERS IN A COMPUTER NETWORK

(71) Applicant: The Toronto-Dominion Bank, Toronto (CA)

(72) Inventors: Andrew David CLARK, Whitby (CA); Lilya JARVIS, Toronto (CA); Starla Michelle SACKS, Toronto (CA)

(73) Assignee: The Toronto-Dominion Bank, Toronto, ON (CA)

(21) Appl. No.: 18/583,283

(22) Filed: Feb. 21, 2024

(51) Int. Cl. G06Q 20/38; G06Q 20/10

(52) U.S. Cl. CPC G06Q 20/38215; G06Q 20/10; G06Q 20/3825; G06Q 20/3829; G06Q 2220/00

(57) ABSTRACT

A computer-implemented method is disclosed. The method includes: receiving, via a computing device, a first request to digitally certify resources for transfer, the first request including an identifier of a first resource account, a recipient identifier, a first quantity of resources to certify, and an expiry time; causing a transfer of the first quantity of resources from the first resource account to a defined intermediate resource account; generating an electronic proof document associated with the digital certification of the resources, the electronic proof document being digitally signed; responsive to receiving, via the computing device, a second request to transfer the digitally certified resources: transmitting, to the recipient entity, a message comprising the electronic proof document and an indication of the expiry time; and processing transfer of the first quantity of resources from the intermediate resource account to the first resource account based on a response action of the recipient entity.

### TECHNICAL FIELD

The present application relates to data security and, more particularly, to methods for managing access to resource accounts in a networked computing environment.

### BACKGROUND

Resource account management entails managing access to resources associated with user accounts and facilitating authorized transfers of resources between accounts. Transfers or intended transfers of resources (e.g., digital, physical, or computing resources) may be “validated” by, for example, certifying that a sufficient quantity of the resources are available to be transferred from a transferor account. In particular, a defined quantity of resources of the transferor account may be designated, or assigned, for a resource transfer. The certification serves as a guarantee, by the sender or an affiliated certification authority, that the designated resources of the transferor account can/will be transferred to a recipient account. The certifying of resources for transfer is often a precondition for one or more subsequent actions in connection with use of said resources.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for handling a request to validate a transfer of resources in a computer network;

FIG. 4 shows, in flowchart form, an example method for processing a transfer of certified resources to a recipient account;

FIG. 5 shows, in flowchart form, an example method for managing data records associated with resource accounts in a computer network; and

FIG. 6 shows, in flowchart form, another example method for processing a transfer of certified resources to a recipient account.

Like reference numerals are used in the drawings to denote like elements and features.

### DETAILED DESCRIPTION OF VARIOUS EMBODIMENTS

In an aspect, the present disclosure describes a computing system. The computing system includes a processor and a memory coupled to the processor. The memory stores computer-executable instructions that, when executed, configure the processor to: receive, via a computing device, a first request to digitally certify resources for transfer, the first request including an identifier of a first resource account, a recipient identifier, a first quantity of resources to certify, and an expiry time; cause a transfer of the first quantity of resources from the first resource account to a defined intermediate resource account; generate an electronic proof document associated with the digital certification of the resources, the electronic proof document being digitally signed; responsive to receiving, via the computing device, a second request to transfer the digitally certified resources: transmit, to the recipient entity, a message comprising the electronic proof document and an indication of the expiry time; and process transfer of the first quantity of resources from the intermediate resource account to the first resource account based on a response action of the recipient entity.

In some implementations, the electronic proof document may comprise a digitally signed document in a portable document format (PDF).

In some implementations, the first resource account and the intermediate resource account may comprise data records at a database associated with a resource management server.

In some implementations, the instructions, when executed, may further configure the processor to: receive, from the recipient entity, a resource claim request to initiate transfer of the certified resources; determine that transfer of the certified resources has not expired; and in response to determining that the transfer of the certified resources has not expired, cause a transfer of the first quantity of resources from the intermediate resource account to the first resource account.

In some implementations, the instructions, when executed, may further configure the processor to: determine that transfer of the certified resources has expired based on the expiry time; and responsive to determining that the transfer of the certified resources has expired, cause a transfer of the first quantity of resources from the intermediate resource account to the first resource account.

In some implementations, the electronic proof document be signed with a private key associated with a resource management server.

In some implementations, the intermediate resource account may be a bank account at a bank that is designated for receiving certified funds from user accounts associated with the bank.

In some implementations, the instructions, when executed, may further configure the processor to: track a current status of transfer of the certified resources; and transmit, to a sender entity, a message containing an indication of the current status of the transfer of the certified resources.

In some implementations, the instructions, when executed, may further configure the processor to: determine that the transfer of the certified resources has expired based on the expiry time; and in response to determining that the transfer of the certified resources has expired, transmit, to the recipient entity, a message indicating an expiry status associated with the transfer.

In some implementations, the second request may comprise a first input, via a user interface associated with a resource management server, for requesting transfer of the digitally certified resources.

In another aspect, the present disclosure describes a computer-implemented method. The method includes: receiving, via a computing device, a first request to digitally certify resources for transfer, the first request including an identifier of a first resource account, a recipient identifier, a first quantity of resources to certify, and an expiry time; causing a transfer of the first quantity of resources from the first resource account to a defined intermediate resource account; generating an electronic proof document associated with the digital certification of the resources, the electronic proof document being digitally signed; responsive to receiving, via the computing device, a second request to transfer the digitally certified resources: transmitting, to the recipient entity, a message comprising the electronic proof document and an indication of the expiry time; and processing transfer of the first quantity of resources from the intermediate resource account to the first resource account based on a response action of the recipient entity.

In yet another aspect, a non-transitory computer readable storage medium is disclosed. The computer readable storage medium contains instructions thereon which, when executed by a processor, configure the processor to: receive, via a computing device, a first request to digitally certify resources for transfer, the first request including an identifier of a first resource account, a recipient identifier, a first quantity of resources to certify, and an expiry time; cause a transfer of the first quantity of resources from the first resource account to a defined intermediate resource account; generate an electronic proof document associated with the digital certification of the resources, the electronic proof document being digitally signed; responsive to receiving, via the computing device, a second request to transfer the digitally certified resources: transmit, to the recipient entity, a message comprising the electronic proof document and an indication of the expiry time; and process transfer of the first quantity of resources from the intermediate resource account to the first resource account based on a response action of the recipient entity.

Other aspects and features of the present application will be understood by those of ordinary skill in the art from a review of the following description of examples in conjunction with the accompanying figures. Example embodiments of the present application are not limited to any particular operating system, system architecture, mobile device architecture, server architecture, or computer programming language.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

A system and methods for certifying resources (e.g., digital, physical, or computing resources) for transfer in a networked computing environment are proposed. Resources may be transferred between resource accounts that are maintained by a computer server. By way of example, digital resources may be transferred to and from user accounts at a resource server. Digital resources may include, for example, digital vouchers, virtual and/or fiat currency, or other stored value objects (e.g., tokens). The disclosed system enables users to obtain digital certification of resources and to securely present or transfer the certified resources to third-party entities.

A user/sender can initiate a process for digitally certifying resources by submitting, to the system, a request to validate a transfer (or intended transfer) of resources. Once the requesting user is authenticated at the system, the user may select an existing resource account and an option to “certify” certain resources associated with the account. The user provides identifying information for a recipient and indicates a quantity of resources (of the selected account) that is to be certified. For example, the user may provide account information for a recipient account and indicate a quantity of resources to designate for a requested transfer from the sender account. The user may also specify a validity period (e.g., defined by an expiry date and/or time) for which the designated resources may be guaranteed and whether the certified resources are to be transferred electronically to the recipient account.

Upon receiving the user's input of the request parameters, the system may cause the designated resources in the selected account to be “frozen”. In at least some implementations, the designated resources are caused to be transferred to an intermediate account that is different from both the sender account and the recipient account. The designated resources may be stored in said intermediate account until the earlier of a transfer of said resources to the recipient account or an expiry date/time specified by the sender.

The system generates a digital “certificate” as a receipt of the certifying of resources. The certificate may, in some implementations, be in the form of an electronic document, such as a PDF, which may be downloaded and saved to the sender's device or transmitted to the sender via a message (e.g., email). The certificate may be digitally signed; for example, a digital signature employing public-key cryptography may be provided with the certificate to confirm that the document originated from a valid certificate authority.

If the sender selects an option to transfer the certified resources, the system may send a message to the recipient (e.g., an email, in-app notification, etc.). The message identifies, to the recipient, an incoming transfer of resources from the sender account. The message may include, at least, the certificate and an indication of the expiry date/time for transfer of the certified resources. The recipient can accept or reject the transfer. If the recipient accepts the transfer, the designated resources of the transfer are caused to be moved, or deposited, to the recipient's account. A status of the resource transfer may be updated to “COMPLETE” (or similar status indicator) upon successful depositing of the designated resources. If, on the other hand, the transfer is not claimed by the expiry time, the recipient is provided with a message indicating that the transfer has expired. The resources that were designated for the transfer may then be moved back to the sender account.

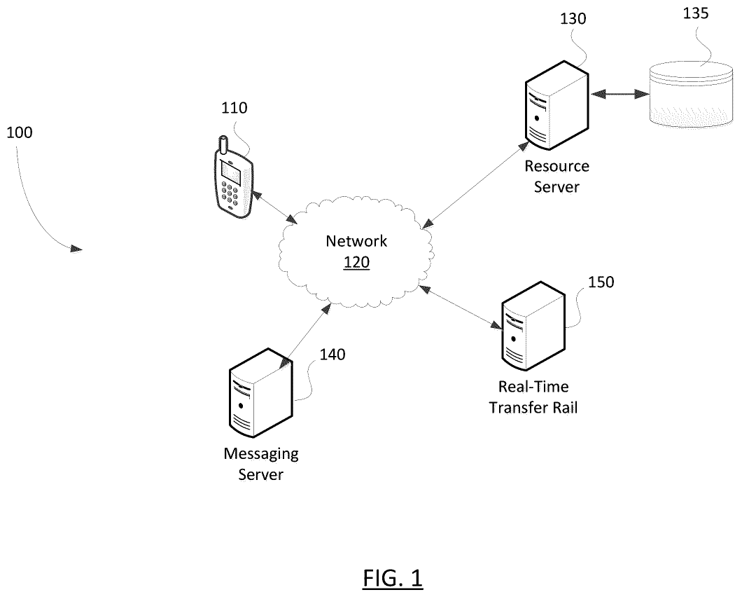

Reference is first made to FIG. 1, which is a schematic diagram illustrating an operating environment of an example embodiment. FIG. 1 illustrates exemplary components of a computing system 100. The computing system 100 may be configured for managing access to resources in a network environment. As a specific example, the computing system 100 may implement one or more of the methods disclosed herein for digitally certifying resources of user accounts associated with a resource management system.

As illustrated, the resource server 130 (which may also be referred to as a resource management system) and one or more client devices 110 communicate via the network 120. The client device 110 is a computing device. For example, the client device 110 may be a device of an entity having resources that are associated with the resource server 130. The client device 110 may take a variety of forms including, for example, a mobile communication device such as a smartphone, a tablet computer, a wearable computer such as a head-mounted display or smartwatch, a laptop or desktop computer, or a computing device of another type.

The resource server 130 may track, manage, and maintain resources, make lending decisions, and/or lend resources for a plurality of clients. The resources may, for example, be computing resources (e.g., memory or processor cycles), stored value (e.g., fiat currency) which may be represented in one or more databases, and the like. For example, as shown in FIG. 1, the resource server 130 may be coupled to a database 135, which may be provided in secure storage. The secure storage may be provided internally within the resource server 130 or externally; the secure storage may, for example, be provided remotely from the resource server 130. In some implementations, the secure storage may include one or more data centers. The data centers may, for example, store data with bank-grade security.

The resource server 130 may include a resource transfer processing engine (not shown in FIG. 1). A resource transfer processing engine may be implemented to automatically process requests to transfer resources. Specifically, the resource transfer processing engine may be configured to process user requests to transfer (e.g., cause to be moved) resources from and/or between resource accounts managed by the resource server 130. The resource transfer processing engine may process transfer requests in accordance with defined handling actions. For example, the resource transfer processing engine may be configured to automatically process transfer requests without manual intervention of related entities (e.g., a resource server administrator, clients associated with the resource accounts, etc.) for the transfer requests.

The database 135 may include records for a plurality of accounts and at least some of the records may define a quantity of resources associated with an entity. For example, the entity that is associated with the client device 110 may be associated with a resource account having one or more records in the database 135. The data records may reflect a quantity of stored resources that are associated with the entity. Such resources may include owned resources and, in at least some implementations, borrowed resources (e.g., resources available on credit). The quantity of resources that are available to or associated with an entity may be reflected by a balance defined in an associated record such as, for example, a bank balance.

In the example of FIG. 1, the resource server 130 may provide both resource transfer processing (e.g., electronic fund transfers) and data holding (e.g., banking) functions. In particular, the resource server 130 may be both a financial institution server and also a payment transaction processing server. The resource server 130 may, in some implementations, be a proxy server, serving as an intermediary for requests of client devices 110 seeking resources from other servers/computers. The resource server 130 may, for example, be a financial institution server and the entity associated with a client device 110 may be a customer of a financial institution operating the financial institution server.

A messaging server 140 is also illustrated in FIG. 1. In at least some implementations, the messaging server 140 may be an email server that handles and delivers email over a network. A mail server is configured to receive emails, store emails in a queue for delivery, and route emails to client computers or other mail servers. The messaging server 140 is a server that is associated with a messaging service, such as emails, SMS (Short Message Service), MMS (Multimedia Messaging Service), and the like. The messaging server 140 may be enabled to send or receive messages in the form of, for example, email, SMS and/or MMS transmissions between local and/or international telecommunications networks. The messages are eventually routed to messaging service-enabled devices for access by clients.

As shown in FIG. 1, the system 100 also includes a real-time transfer rail 150. In at least some implementations, the real-time transfer rail 150 may be a payment rail. For example, the real-time transfer rail 150 may be hosted by a real-time payment system that includes a real-time payment server. The real-time payment system may be associated with a third-party and be configured to receive a resource transfer request. The transfer request may include a request to transfer resources associated with a first data record to at least one second data record. The first data record may comprise a data record of a sender and the second data record may comprise a data record of a recipient. For example, the first data record may be associated with a first financial institution database and the second data record may be associated with a second financial institution database.

In some implementations, the request to transfer resources may be a request to transfer data such as, for example, units of value. The units of value may include a quantity of currency. The sender may initiate the transfer request using, for example, a computing device. The transfer request may be formatted as an ISO2022 message and may include one or more parameters. The ISO2022 format is a data-rich messaging format that provides the real-time transfer rail 150 with a clear and nuanced format of data. The one or more parameters may be included as metadata in the transfer request. The parameters may include, for example, resource definition data. The resource definition data defines what is requested to be transferred. By way of example, the resource definition data may define a resource that is stored in or otherwise associated with a data record associated with the sender. The resource may represent units of value, such as a quantity of a currency.

In response to receiving a transfer request, the real-time payment system may complete the requested resource transfer using the real-time transfer rail 150. Specifically, the real-time payment server may be configured to receive the transfer request and to facilitate the resource transfer from the first data record associated with the sender to the second data record associated with the recipient in real-time. In some implementations, the resource transfer may be irrevocable; that is, the sender may not be able to retrieve the transferred resources after completion of the transfer.

The real-time transfer rail 150 is configured to complete transfer requests in real-time or substantially in real-time. In at least some implementations, real-time is defined as being within seconds. Certain factors, such as network traffic, may limit the immediacy of real-time transfers and/or processing of transfer requests.

The client device 110 may be used, for example, to configure a request to transfer resources of a resource account associated with the client device 110. More particularly, the client device 110 may be used to generate requests to transfer resources from a resource account (or data records associated therewith) of an entity operating the client device 110. A resource transfer may, for example, involve a transfer of data between a record in the database 135 associated with an account at the resource server 130 and another record in the database 135 (or in another database). The data involved in the resource transfer may, for example, be units of value and the records involved in the resource transfer may be adjusted in related or corresponding manners. For example, during a resource transfer, a record associated with the intended recipient (i.e., transferee) of the transfer may be adjusted to reflect an increase in value resulting from the transfer, whereas the record associated with the entity (i.e., sender) initiating the transfer may be adjusted to reflect a decrease in value which is at least as large as the increase in value applied to the record associated with the transferee.

The client devices 110, the resource server 130, and the messaging server 140 may be in geographically disparate locations. Put differently, the client devices 110 may be remote from the resource server 130 and/or the messaging server 140. As explained herein, each of the client devices 110, the resource server 130, and the messaging server 140 is a computing system.

The network 120 is a computer network. In some implementations, the network 120 may be an internetwork such as may be formed of one or more interconnected computer networks. For example, the network 120 may be or may include an Ethernet network, an asynchronous transfer mode (ATM) network, a wireless network, or the like.

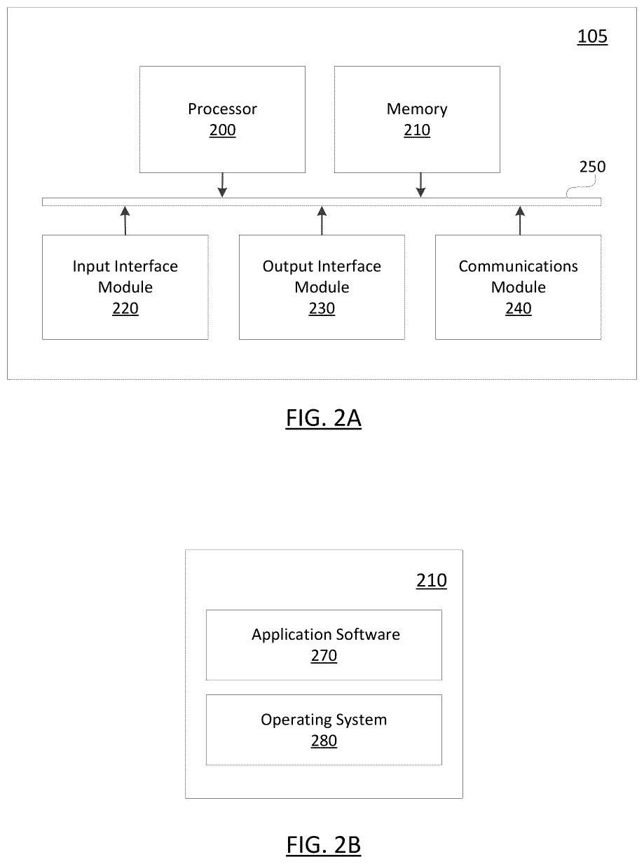

FIG. 2A is a high-level operation diagram of an example computing device 105. In at least some implementations, the example computing device 105 may be exemplary of one or more of the client devices 110, the resource server 130, and the messaging server 140. The example computing device 105 includes a variety of modules. For example, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards.

For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280.

The application software 270 adapts the example computing device 105, in combination with the operating system 280, to operate as a device performing a particular function. The operating system 280 is software. The operating system 280 allows the application software 270 to access the processor 200, the memory 210, the input interface module 220, the output interface module 230 and the communications module 240. The operating system 280 may be, for example, Apple's iOS™, Google's Android™, Linux™, Microsoft Windows™, or the like.

In some implementations, the application software 270 may comprise a resource management application. The resource management application may, for example, be a personal banking application that is used to manage one or more bank accounts. The resource management application may provide various functions such as resource transfers (e.g., electronic fund transfers, etc.), display of account balances, and other account management functions. For example, the resource management application may enable a user to digitally certify resources associated with the user's account. Using the resource management application, a user may select an account, indicate a quantity of resources to certify for a transfer (or intended transfer), and optionally identify a recipient account for the transfer.

Additionally, the resource management application may enable a user to configure requests to transfer resources from the user's account. In particular, the resource management application may be used to generate transfer requests. A sender entity may input information, or parameters, for defining a transfer request, such as account information for a recipient account, quantity of resources to be designated for the transfer, and related requirements for the transfer (e.g., transfer validity period). Once it is defined, the transfer request can be routed to a computing system for processing resource transfers. For example, the transfer request may be provided to a resource server that manages the account(s) of the sender entity.

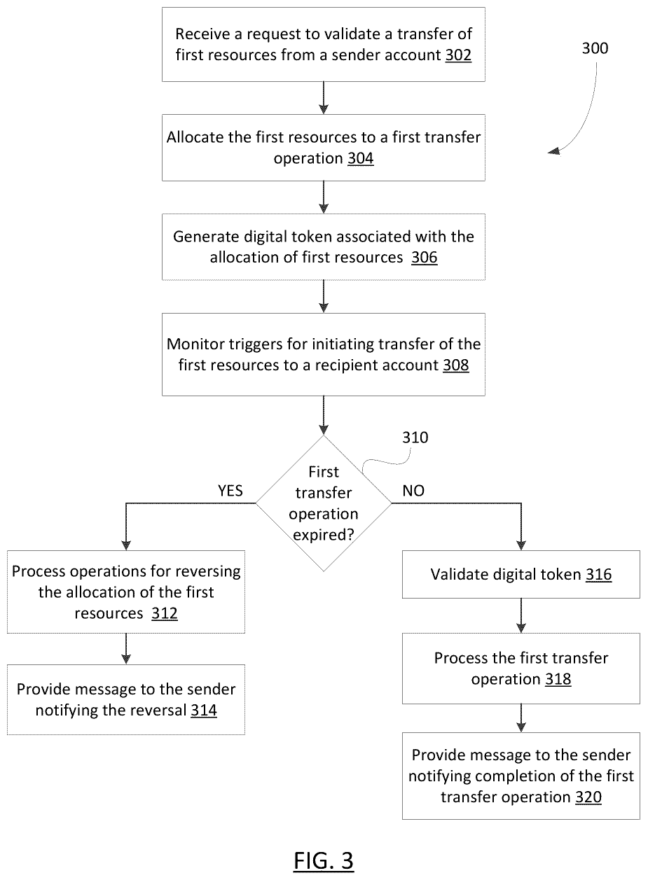

Reference is now made to FIG. 3, which shows, in flowchart form, an example method 300 for handling a request to validate a transfer of resources in a computer network. The method 300 may be implemented by an access management system, such as the resource server 130 of FIG. 1. In particular, a computing system that is configured for controlling access to resources associated with one or more user accounts may implement the method 300. Operations starting with operation 302 and continuing onward may be performed, for example, by the processor 200 (FIG. 2A) of a computing device 105 executing software comprising instructions such as may be stored in the memory 210 of the computing device 105. Specifically, processor-executable instructions may, when executed, configure a processor 200 of a resource server 130 to perform all or parts of the method 300.

The resources associated with a user account may be transferred to one or more different user accounts. A transfer or intended transfer of resources may be “validated” by, for example, (1) directly or indirectly causing certain resources of a sender account to be moved to a recipient account, and/or (2) demonstrating that a sufficient quantity of resources is available in the sender account for the (intended) transfer. A resource transfer would typically be validated by means of a physical instrument, such as a certified cheque, containing a certification that resources are available for the transfer. This traditional approach for validating transfers generally requires in-person interactions for requesting and obtaining the physical instrument, which imposes unnecessary burdens on the sender and heightens risks of delays and manual errors in the validation process. Moreover, the requirement of in-person interactions places additional constraints (e.g., coordinated meeting time and location) on the ability of users to request validation of their desired resource transfers.

The methods described herein, including method 300, support increased flexibility and efficiency in validating resource transfers. A resource server receives, via a computing device, a request to validate a transfer of first resources from a sender account, in operation 302. The first resources comprise a defined quantity of resources of the sender account (1) that are requested to be transferred to a recipient account, and/or (2) the availability of which is requested to be formally certified. The request may originate from a device associated with a sender, i.e., an owner or another authorized entity associated with a sender account. For example, the sender may input the request via a user interface associated with software on their device for managing their resource account.

The request may indicate, among others, a selection of a resource account (i.e., the sender account) as well as a type and quantity of resources for the transfer. Additionally, the request may include identifying information for a recipient and/or recipient account. In at least some implementations, the sender may request that the resource transfer be digitally certified. For example, the request may include an indication that digital certification of resources for the transfer is desired or required.

In operation 304, the resource server allocates the first resources to a first transfer operation. That is, the first resources are designated, or assigned, for the first transfer operation. The first transfer operation represents a transfer of resources from the sender account. The actual transfer, i.e., depositing of the resources in a recipient account, may not take place. Instead, the validation process may allow for certifying that the first resources (1) are available in the sender account, and (2) can be designated for transferring to a recipient account.

The allocation of the first resources to the first transfer operation ensures that said resources (or the same quantity of equivalent resources of the sender account) are not also available for other transfer operations. In particular, the allocation “binds” the first resources to the first transfer operation, thereby fixing, at least temporarily, the use of the first resources. If another transfer operation is subsequently configured for the sender account, the first resources will not be available for such subsequent operation. In other words, the pool of available resources of the sender account for a transfer operation that is subsequent to the first transfer operation does not include the first resources (or is reduced by the quantity of first resources). For example, a remaining resource balance for the sender account will reflect that the first resources are designated for the first transfer operation.

In some implementations, the first resources may be caused to be transferred to an intermediate resource account that is different from the sender and recipient accounts. The first resources may be stored, or maintained, in the intermediate resource account until an actual transfer of the first resources occurs, the first transfer operation expires, or the first resources are transferred back to the sender account. A memory associated with the intermediate resource account may store the association between the first resources and the first transfer operation. In this way, the first resources may be removed from the sender account, at least temporarily, for committing to a particular transfer operation.

In some implementations, the first resources may be allocated to the first transfer operation simply by storing an association between the first resources and the first transfer operation in a memory of the resource server. The stored association may form a virtual resource lock on the first resources. Once the first resources are “locked”, they may not be committed for any other use/operation unless and until the resource lock is disabled. This approach of using a virtual resource lock may obviate the need for having to transfer the first resources to an account that is different from the sender account.

In operation 306, the resource server generates a digital token associated with the allocation of the first resources. The digital token is a piece of reference data that can be used as proof of certification of the first resources that are designated for the first transfer operation. In some implementations, the digital token may be in the form of an electronic document, such as a document in portable document format (PDF). For example, the resource server may generate an electronic document that uniquely identifies resources of the sender account that are designated for the first transfer operation. Once generated, the electronic document may be saved to the sender device or shared, for example, by a message (e.g., email) with one or more recipient entities.

Additionally, or alternatively, the digital token may be formatted as a machine-readable data representation, such as a barcode. The digital token may encode data associated with the first transfer operation. By way of example, the digital token may comprise, or incorporate, sender account information and/or a unique identifier of the first transfer operation. The digital token may encode additional transfer parameters, such as the quantity of the designated first resources, recipient account information, transfer validity period, and the like.

The resource server is configured to detect trigger conditions for initiating the first transfer operation of transferring the first resources to a recipient account (operation 308). In some implementations, the resource server may receive, via a device of the intended recipient, a request to initiate the first transfer operation. That is, the recipient can directly “claim” the transfer of the first resources to the recipient's account. By way of example, the resource server may receive, via the recipient's device, user input indicating the recipient's intention to claim a transfer of the first resources from the sender account. The recipient's input for claiming the first resources may be detected as a trigger condition. A message, such as an email, containing the digital token may be transmitted to the recipient. The message may be presented in an interface that allows the recipient to provide input for requesting that the first transfer operation proceed. For example, a user interface element associated with a request for claiming the first resources may be actuated by the recipient.

As another example, the sender may indicate an intention to initiate the first transfer operation to transfer the first resources to a particular recipient account. As part of the request to validate the transfer of the first resources (operation 302), the sender may specify that they would like the certified resources to be transferred to the recipient account. Upon successful certification, the first resources that are designated for the first transfer operation may be automatically transferred. This trigger condition would cause the resource server to automatically initiate the transfer of the first resources to the recipient, even in the absence of an action by the recipient to claim the first resources.

The first transfer operation may be associated with a fixed validity period. The validity period may be defined, for example, by the sender specifying an expiry date and/or time for the first transfer operation. The expiry date/time may be indicated, for example, in the sender's request to validate the transfer of the first resources (operation 302). Once the validity period ends, the first resources may no longer be transferred via the first transfer operation. In particular, upon expiry of the validity period, the first resources are no longer bound to the first transfer operation, and may become available for other operations/uses.

If the first transfer operation is determined to be expired (operation 310) at the time of detecting the trigger condition, the resource server may process operations for reversing the allocation of the first resources, in operation 312. In at least some implementations, a virtual resource lock on the first resources may be disabled to reverse the allocation. The first resources may then no longer be bound to the first transfer operation. The disabling of the resource lock may occur immediately upon expiry of the validity period of the first transfer operation. Alternatively, the resource lock may occur only after a confirmatory action by the sender. For example, the sender may be prompted, on their device, at the end of the validity to input a confirmation that the first transfer operation is to be canceled. The resource server then provides, to the sender, a message or notification that the transfer of the first resources has been reversed.

In some implementations, the first resources may be caused to be transferred back to the sender account. In instances where the first resources are moved to an intermediate resource account, the expiry of the validity period may cause the first resources to be automatically transferred back to the sender account. That is, the first resources are returned to the pool of available resources associated with the sender account.

If, on the other hand, the first transfer operation is not expired at the time of detecting the trigger condition, the resource server causes the digital token to be validated, in operation 316. The digital token is a representation of the certification of the first resources for the first transfer operation. The sender and/or the recipient may present the digital token as part of requesting that the first resources be transferred to the recipient account. By validating the digital token, the resource server can verify the identity of the requesting entity and the quantity of resources for transfer represented by the digital token.

In response to determining that the digital token associated with the first transfer operation is valid, the resource server processes the first transfer operation (operation 318). That is, the first resources designated for the first transfer operation are moved, or deposited, to the recipient account. In operation 320, the resource server provides a message to the sender notifying completion of the first transfer operation. Specifically, the message indicates that a status of the first transfer operation is “COMPLETE” (or similar indicator of completion). Additionally, a message may be sent to the recipient confirming the deposit of the first resources into their account.

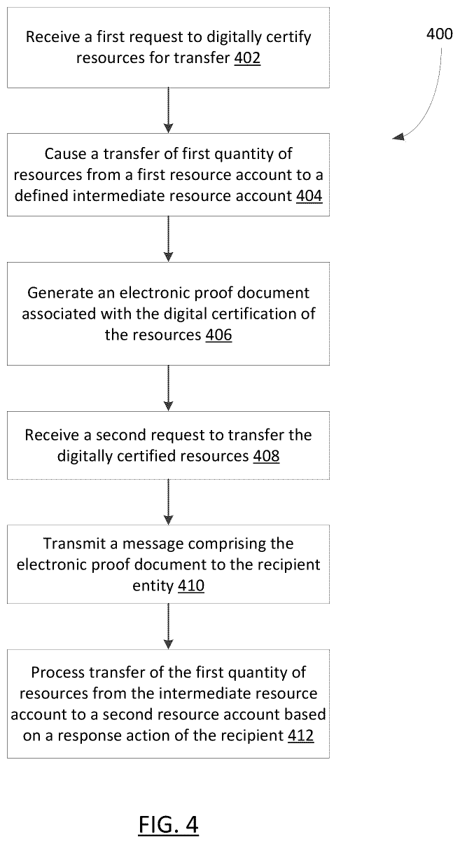

Reference is now made to FIG. 4 which shows, in flowchart form, an example method 400 for processing a transfer of digitally certified resources to a recipient account. The method 400 may be implemented by an access management system, such as the resource server 130 of FIG. 1. In particular, a resource server 130 may perform the method 400 as part of a process for handling requests to digitally certify resources of a resource account. The operations of method 400 may be performed in addition to, or as alternatives of, one or more of the operations of method 300.

In operation 402, the resource server receives a first request to digitally certify resources for transfer. The first request originates from a device of a sender entity. Specifically, a user associated with a resource account may generate, using their device, a request to digitally certify certain resources from their account which are intended to be designated for a transfer operation. The first request may thus be generated at a client device (of the sender) and transmitted to the resource server. The first request includes, at least, an identifier of a resource account (i.e., sender account), a recipient identifier, a first quantity of resources to certify, and a validity period (e.g., expiry date/time) associated with the transfer.

In operation 404, the resource server causes a transfer of the first quantity of resources from the first resource account to a defined intermediate resource account. The first resource account and the intermediate resource account may comprise data records of a database associated with a resource management server. The intermediate resource account may, for example, be a bank account that is designated for receiving certified funds from accounts of customers of the bank. The intermediate resource account may be an internal bank account that is of a different type than customer accounts. In particular, the intermediate resource account is not accessible to customers of the bank, and transfers into and out of the intermediate resource account may only be initiated by a non-customer entity that is authorized to manage the intermediate resource account (including any certified funds contained therein).

In operation 406, the resource server generates an electronic proof document associated with the digital certification of the resources, the electronic proof document being digitally signed. The electronic proof document serves as receipt of the allocation of a defined quantity of resources of the sender account to a transfer (or intended transfer) operation. In at least some implementations, the electronic proof document comprises a digitally signed document in a portable document format (PDF). The electronic proof document may be signed with a private key associated with a resource management server, such as a bank institution. The electronic proof document can be saved to the sender's device or transmitted to the recipient entity (e.g., via email, text message, etc.).

The resource server receives, via the computing device, a second request to transfer the digitally certified resources (operation 408). The second request may comprise an input, via a user interface associated with a resource management server, for requesting transfer of the digitally certified resources. The second request may originate from the sender or an intended recipient. For example, the sender may request that the resource server process the transfer at a time following digital certification of the resources designated for the transfer. Alternatively, the sender may indicate, as part of the request for digitally certifying the resources, that the resources are to be transferred to a recipient account subsequent to certification.

In some implementations, the sender may provide only the electronic proof document to the recipient, and the recipient may request that the transfer of the digitally certified resources be processed. In particular, the recipient, upon receiving a message containing the electronic proof document (and optionally, an indication of the validity period of the transfer), may request that the resource server initiate, or cause to be initiated, the transfer. The electronic proof document (or other form of digital certification) may be required to be presented in order for the transfer to be processed.

Where the sender requests the transfer of the digitally certified resources, in response to receiving the second request, the resource server transmits, to the recipient entity, a message comprising the electronic proof document and an indication of the validity period, in operation 410. The message may be in the form of an email, an in-app notification, etc. that notifies the recipient that a transfer of digitally certified resources is available to be claimed by the recipient, within the validity period. For example, the message may be automatically sent to the recipient upon completion of the digital certification of the resources.

In operation 412, the resource server processes transfer of the first quantity of resources from the intermediate resource account to a second resource account based on a response action of the recipient entity. The second resource account represents an account associated with the recipient. The recipient may indicate their intention to claim the digitally certified resources, by providing, via their device, input for responding to the message containing the electronic proof document. The input may comprise, for example, a selection of (1) a user interface element for accepting the transfer of the digitally certified resources, and (2) a resource account that is to receive the transfer.

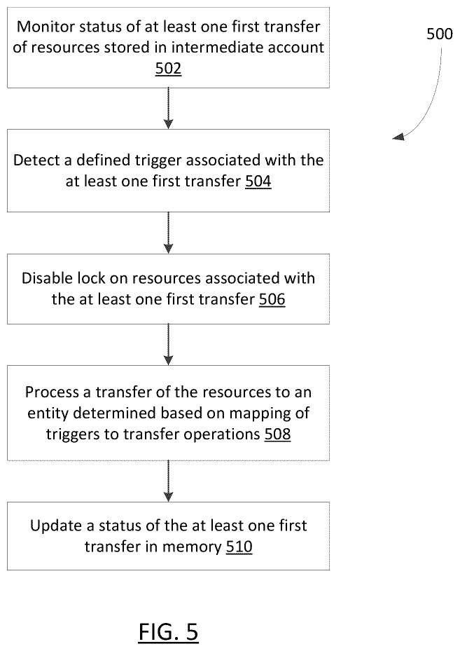

Reference is now made to FIG. 5 which shows, in flowchart form, an example method 500 for managing data records associated with resource accounts in a computer network. The method 500 may be implemented by an access management system, such as the resource server 130 of FIG. 1. In particular, a resource server 130 may perform the method 500 as part of a process for handling requests to digitally certify resources of a resource account. The operations of method 500 may be performed in addition to, or as alternatives of, one or more of the operations of methods 300 and 400.

As described above, an intermediate resource account may be employed for temporarily storing certified resources that are designated for a transfer or intended transfer from a sender account. The intermediate resource account may be managed by the same entity that manages the sender account and/or recipient account. In some implementations, the intermediate resource account is an internal account that is inaccessible to users associated with user accounts. For example, the intermediate resource account may only be accessed by an administrator entity associated with the resource server. Transfers of resources from and to the intermediate resource account may only be authorized by the administrator. In operation 502, the resource server monitors the status of transfers of resources that are stored in the intermediate resource account. Specifically, the resource server performs a check to determine the status of each of one or more pending transfers of resources that are stored in the intermediate resource account. The status checks may be performed on a periodic basis (e.g., daily, hourly, etc.) or at predetermined times, e.g., according to a defined monitoring schedule.

In operation 504, the resource server detects a defined trigger condition associated with at least one first transfer of resources from the intermediate resource account. In particular, the resource server may determine that an expiry condition associated with transfer of a certain quantity of resources is satisfied. For example, the resource server may verify that a validity period of a transfer operation for transferring a certain quantity of designated resources has ended, i.e., an expiry date/time has passed. Such transfer for which the validity period has ended may be associated with an “EXPIRED” (or similar) status. More generally, the resource server may be configured to check the expiry condition of each of one or more defined transfer operations of transferring resources from the intermediate resource account.

In operation 506, the resource server disables a resource lock on resources associated with the at least one first transfer. A resource lock represents a lock on a certain quantity of resources that are designated for a defined resource transfer operation. By disabling the resource lock, the resources are no longer bound to the at least one first transfer and become available for subsequent operations. For example, once a resource lock on a defined quantity of resources is disabled, said resources may be transferred back to an account (e.g., sender account) from which they originated.

In operation 508, the resource server processes a transfer of the resources to an entity determined based on a mapping of trigger conditions to transfer operations. In at least some implementations, the resources that were designated for the transfer are returned to the pool of available resources of the associated sender account. Specifically, the resource server causes the resources to be transferred from the intermediate resource account back to the relevant sender account. More generally, each trigger condition may be associated with an indication of a resource account to which the resources are to be transferred. The resources may be transferred back to the sender account, or to another account that is different from the intended recipient of the at least one first transfer. In this way, the resource server exercises control over when and where the designated resources for a transfer operation are to be moved from the intermediate resource account.

In operation 510, the resource server updates a status of the at least one first transfer in memory. For example, the status of the at least one first transfer may be set to “EXPIRED”, or “RETURNED”, upon expiry of a validity period and/or transfer of the resources back to the sender account. As another example, the status of the transfer may indicate an identifier of another account to which the resources are transferred from the intermediate resource account.

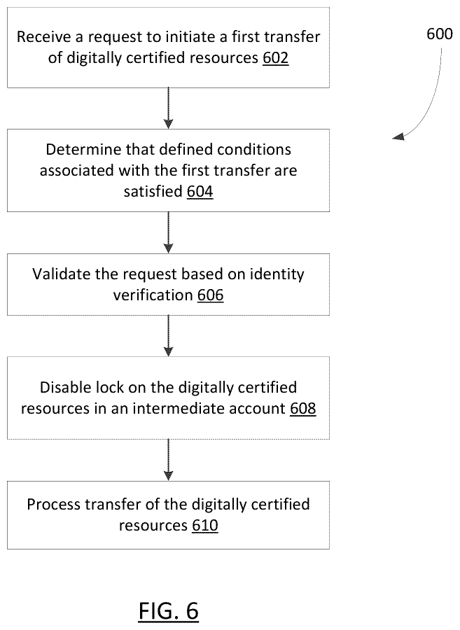

Reference is now made to FIG. 6, which shows, in flowchart form, another example method 600 for processing a transfer of digitally certified resources to a recipient account. The method 600 may be performed by a resource management system, such as the resource server 130 of FIG. 1. Operations starting with operation 602 and continuing onward may be performed, for example, by the processor 200 (FIG. 2A) of a computing device 105 executing software comprising instructions such as may be stored in the memory 210 of the computing device 105. In particular, processor-executable instructions may, when executed, configure a processor 200 of the resource server 130 to perform all or parts of the method 600. The operations of method 600 may be performed in addition to, or as alternatives of, one or more of the operations of methods 300 to 500.

The resource server may receive a request to initiate a first transfer of digitally certified resources, in operation 602. The request may indicate identifying information of a recipient, a quantity of resources to be certified, and a requested time of transfer of the certified resources. The digital certifying of the resources may proceed in accordance with the mechanisms described herein with respect to any one of methods 300 to 500.

In operation 604, the resource server determines that at least one defined condition associated with the first transfer is satisfied. The condition may relate to timing of the first transfer as requested by the sender or receipt of input by the recipient for claiming the certified resources. In particular, a defined condition may be determined to be satisfied if the recipient provides input for requesting that the first transfer of the certified resources to the recipient account be processed.

In operation 606, the resource server validates the request based on identity verification. Specifically, the identity of the requesting entity, i.e., the sender or the intended recipient, of the first transfer is verified by the resource server. As part of the verification, the resource server may process a digital certification of the resources, such as a proof document or other form of certification, and verify that the recipient entity is associated with the digital certification. For example, the resource server may verify identifying information provided by the recipient matches the corresponding recipient data as indicated for the digital certification.

In operation 608, the resource server disables a resource lock on the digitally certified resources in an intermediate resource account. The resource lock represents a lock that binds the certified resources to the first transfer and prevents the movement of the certified resources from the intermediate resource account. While the resource lock is in effect, the resources cannot be moved to any other resource account, such as the sender account or recipient account. The resource lock may be disabled only upon validation of the request to process the first transfer of the certified resources.

In operation 610, the resource server processes transfer of the digitally certified resources. More particularly, the certified resources are caused to be transferred, or deposited, into a recipient account.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above.

In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a memory coupled to the processor, the memory storing computer-executable instructions that, when executed by the processor, configure the processor to:
receive, via a computing device, a first request to digitally certify resources for transfer, the first request including an identifier of a first resource account, a recipient identifier, a first quantity of resources to certify, and an expiry time;
cause a transfer of the first quantity of resources from the first resource account to a defined intermediate resource account;
generate an electronic proof document associated with the digital certification of the resources, the electronic proof document being digitally signed;
responsive to receiving, via the computing device, a second request to transfer the digitally certified resources:
transmit, to the recipient entity, a message comprising the electronic proof document and an indication of the expiry time; and
process transfer of the first quantity of resources from the intermediate resource account to the first resource account based on a response action of the recipient entity.

2. The computing system of claim 1, wherein the electronic proof document comprises a digitally signed document in a portable document format (PDF).

3. The computing system of claim 1, wherein the first resource account and the intermediate resource account comprise data records at a database associated with a resource management server.

4. The computing system of claim 1, wherein the instructions, when executed, further configure the processor to:
receive, from the recipient entity, a resource claim request to initiate transfer of the certified resources;
determine that transfer of the certified resources has not expired; and
in response to determining that the transfer of the certified resources has not expired, cause a transfer of the first quantity of resources from the intermediate resource account to the first resource account.

5. The computing system of claim 1, wherein the instructions, when executed, further configure the processor to:
determine that transfer of the certified resources has expired based on the expiry time; and
responsive to determining that the transfer of the certified resources has expired, cause a transfer of the first quantity of resources from the intermediate resource account to the first resource account.

6. The computing system of claim 1, wherein the electronic proof document is signed with a private key associated with a resource management server.

7. The computing system of claim 1, wherein the intermediate resource account comprises a bank account at a bank that is designated for receiving certified funds from user accounts associated with the bank.

8. The computing system of claim 1, wherein the instructions, when executed, further configure the processor to:
track a current status of transfer of the certified resources; and
transmit, to a sender entity, a message containing an indication of the current status of the transfer of the certified resources.

9. The computing system of claim 4, wherein the instructions, when executed, further configure the processor to:
determine that the transfer of the certified resources has expired based on the expiry time; and
in response to determining that the transfer of the certified resources has expired, transmit, to the recipient entity, a message indicating an expiry status associated with the transfer.

10. The computing system of claim 1, wherein the second request comprises a first input, via a user interface associated with a resource management server, for requesting transfer of the digitally certified resources.

11. A computer-implemented method, comprising:
receiving, via a computing device, a first request to digitally certify resources for transfer, the first request including an identifier of a first resource account, a recipient identifier, a first quantity of resources to certify, and an expiry time;
causing a transfer of the first quantity of resources from the first resource account to a defined intermediate resource account;
generating an electronic proof document associated with the digital certification of the resources, the electronic proof document being digitally signed;
responsive to receiving, via the computing device, a second request to transfer the digitally certified resources:
transmitting, to the recipient entity, a message comprising the electronic proof document and an indication of the expiry time; and
processing transfer of the first quantity of resources from the intermediate resource account to the first resource account based on a response action of the recipient entity.

12. The method of claim 11, wherein the electronic proof document comprises a digitally signed document in a portable document format (PDF).

13. The method of claim 11, wherein the first resource account and the intermediate resource account comprise data records at a database associated with a resource management server.

14. The method of claim 11, further comprising:
receiving, from the recipient entity, a resource claim request to initiate transfer of the certified resources;
determining that transfer of the certified resources has not expired; and
in response to determining that the transfer of the certified resources has not expired, causing a transfer of the first quantity of resources from the intermediate resource account to the first resource account.

15. The method of claim 11, further comprising:
determining that transfer of the certified resources has expired based on the expiry time; and
responsive to determining that the transfer of the certified resources has expired, causing a transfer of the first quantity of resources from the intermediate resource account to the first resource account.

16. The method of claim 11, wherein the electronic proof document is signed with a private key associated with a resource management server.

17. The method of claim 11, wherein the intermediate resource account comprises a bank account at a bank that is designated for receiving certified funds from user accounts associated with the bank.

18. The method of claim 11, further comprising:
tracking a current status of transfer of the certified resources; and
transmitting, to a sender entity, a message containing an indication of the current status of the transfer of the certified resources.

19. The method of claim 14, further comprising:
determining that the transfer of the certified resources has expired based on the expiry time; and
in response to determining that the transfer of the certified resources has expired, transmitting, to the recipient entity, a message indicating an expiry status associated with the transfer.

20. The method of claim 11, wherein the second request comprises a first input, via a user interface associated with a resource management server, for requesting transfer of the digitally certified resources.
